(19) United States
(12) Patent Application Publication
(10) Pub. No.: US 2015/0243035 A1
(43) Pub. Date: Aug. 27, 2015

(54) METHOD AND DEVICE FOR DETERMINING A TRANSFORMATION BETWEEN AN IMAGE COORDINATE SYSTEM AND AN OBJECT COORDINATE SYSTEM ASSOCIATED WITH AN OBJECT OF INTEREST

(71) Applicant: Metaio GmbH, Munich (DE)

(72) Inventors: Rajesh Narasimha, Plano, TX (US); Pavan Kumar Anasosalu, Dallas, TX (US)

(73) Assignee: Metaio GmbH, Munich (DE)

(21) Appl. No.: 14/186,809

(22) Filed: Feb. 21, 2014

(51) Int. Cl. G06T 7/00; G06T 17/00; G06T 19/20

(52) U.S. Cl. CPC G06T 7/0046; G06T 19/20; G06T 17/005; G06T 7/0051; G06T 2207/10028; G06T 2207/20081; G06T 2207/30244

(57) ABSTRACT

A method of determining a transformation is provided between an image coordinate system and an object coordinate system including: providing an object coordinate system associated with the object of interest, providing a 3D model of at least part of the object of interest, wherein the 3D model comprises 3D features, providing an N-th input depth image of at least part of the object of interest, wherein an N-th image coordinate system is associated with the N-th input depth image, providing an N-th plurality of 3D features in the N-th image coordinate system according to the N-th input depth image, estimating an N-th coarse transformation between the object coordinate system and the N-th image coordinate system according to a trained pose model and the N-th input depth image, and determining an N-th accurate transformation between the N-th image coordinate system and the object coordinate system.

### BACKGROUND OF THE INVENTION

1. Technical Field

The present disclosure is related to a method and device for determining a transformation between an image coordinate system and an object coordinate system associated with an object of interest.

2. Background Information

Three dimensional (“3D”) reconstruction is a common task in multiple application fields. For example, in Augmented Reality (“AR”) applications, virtual visual content (such as computer generated objects) may be overlaid onto an image of an object of interest based on a reconstructed 3D model of the object of interest. 3D reconstruction is commonly referred to as to build a 3D geometrical shape and/or textures of an object. One exemplary approach is to use range sensors. The range sensors may only provide very few measurements at one time which introduces difficulty to the 3D reconstruction. According to another approach, vision based approaches are commonly used for reconstructing a 3D model of an object according to one or more two dimensional (“2D”) images of the object.

In AR applications, images of the object of interest are captured to provide a real view of the object of interest. These images may be directly used to reconstruct the 3D model. Recently, depth images, i.e. 2D images with depth information for pixels, are also available for 3D reconstruction. Generally, more than one depth image may have to be acquired in order to reconstruct a large part of the object (build a 3D model covering a large part of the object). A new input depth image is often merged to an existing 3D model of the object in order to extend the 3D model to cover additional parts of the object. For this, an accurate spatial transformation between the coordinate systems of the new input depth image and the existing 3D model are crucial for adding the information of the new input depth image to the existing 3D model.

Rusinkiewicz et al. “Real-time 3D model acquisition.” ACM Transactions on Graphics (TOG). Vol. 21. No. 3. ACM, 2002 propose a 3D reconstruction method based on frame-to-frame tracking to align a new input image with an existing 3D model. The pose of each new input image is estimated by registration against just the last input image based on iterative closest point (ICP). Accumulation of errors resulted from each registration may lead to poor estimated poses and thus a poor reconstruction is obtained.

Newcombe et al. “KinectFusion: Real-time dense surface mapping and tracking.” Mixed and augmented reality (ISMAR), 2011 10th IEEE international symposium on. IEEE, 2011 propose to estimate a pose of a new input image by using an iterative closest point method to align depth measurement of the new input image with a prediction model generated from an existing 3D model according to the pose of the last input image. Then the information of the new input image is merged into the existing 3D model according to the estimated pose.

Anasosalu et al. in “Compact and Accurate 3-D Face Modeling Using an RGB-D Camera: Let's Open the Door to 3-D Video Conference.” Proc. of 3rd IEEE Workshop on Consumer Depth Cameras for Computer Vision (CDC4CV2013), pp. 67-74, 2013 develop a method for face 3D reconstruction based on depth images captured by a depth camera. In their system setup, the depth camera locates at a fixed position relative to a real world, while the head moves relative to the depth camera during depth image acquisition. One constraint of their method is that the relative movement of the head between acquiring two successive depth images must be small.

One common problem in the above-cited references is that the new input image and the last input image must have sufficient overlap, i.e. the two images have to be captured by the camera at close positions. Iterative closest point methods require a good initial guess, otherwise convergence at an incorrect local minimum (i.e. incorrect result) may be obtained. Therefore, if there is a large displacement between the new input image and the last input image, the methods in the above-cited references may fail.

Several works have been developed to initialize iterative closest point methods.

Aghili, Farhad, et al. “Fault-tolerant position/attitude estimation of free-floating space objects using a laser range sensor.” Sensors Journal, IEEE 11.1 (2011): 176-185 develops an initialization method for iterative closest point methods based on a closed-loop cycle with an Extended Kalman Filter (EKF).

Different methods (see Joung, J. H. et al. “3D environment reconstruction using modified color ICP algorithm by fusion of a camera and a 3D laser range nder, Intelligent Robots and Systems (IROS), WEE/RSJ International Conference on, pp. 3082-3088, October 2009; Henry et al. “RGB-D mapping: Using depth cameras for dense 3D modeling of indoor environments.” In Proceedings of the International Symposium on Experimental Robotics (ISER), December 2010; N. Engelhard et al. “Real-time 3D visual slam with a hand-held rgb-d camera”. In Proc. of the RGB-D Workshop on 3D Perception in Robotics at the European Robotics Forum, April 2011; S. Druon et al. “Color constrained ICP for registration of large unstructured 3D color data sets”. In IEEE International Conference on Information Acquisition, pages 249-255, August 2006) propose to use color information and/or high level feature descriptor (e.g. SIFT and SURF) extracted in two depth images in order to estimate an initial match between two 3D point clouds of the two depth images for iterative closest point methods.

It would be desirable to provide a method and device for determining a transformation between an image coordinate system and an object coordinate system associated with an object of interest which is capable of having less constraints about displacement between any input images.

### SUMMARY OF THE INVENTION

According to an aspect, there is disclosed a method of determining a transformation between an image coordinate system and an object coordinate system associated with an object of interest, comprising:
(a) providing an object coordinate system associated with the object of interest,
(b) providing a 3D model of at least part of the object of interest, wherein the 3D model comprises 3D features,
(c) providing an N-th input depth image of at least part of the object of interest, wherein an N-th image coordinate system is associated with the N-th input depth image, with N being a positive integer;
(d) providing an N-th plurality of 3D features in the N-th image coordinate system according to the N-th input depth image,
(e) estimating an N-th coarse transformation between the object coordinate system and the N-th image coordinate system according to a trained pose model and the N-th input depth image, and
(f) determining an N-th accurate transformation between the N-th image coordinate system and the object coordinate system according to the N-th coarse transformation, at least part of the N-th plurality of 3D features, and at least part of the 3D features of the 3D model.

According to another aspect, there is disclosed a device for determining a transformation between an image coordinate system and an object coordinate system associated with an object of interest, comprising at least one processing device which is configured to:
(a) provide an object coordinate system associated with the object of interest,
(b) provide a 3D model of at least part of the object of interest, wherein the 3D model comprises 3D features,
(c) receive an N-th input depth image of at least part of the object of interest, and to provide an N-th image coordinate system associated with the N-th input depth image, with N being a positive integer,
(d) provide an N-th plurality of 3D features in the N-th image coordinate system according to the N-th input depth image,
(e) estimate an N-th coarse transformation between the object coordinate system and the N-th image coordinate system according to a trained pose model and the N-th input depth image, and
(f) to determine an N-th accurate transformation between the N-th image coordinate system and the object coordinate system according to the N-th coarse transformation, at least part of the N-th plurality of 3D features, and at least part of the 3D features of the 3D model.

Advantageously, aspects of the invention as disclosed herein propose a method for 3D reconstruction with less or even without constraints about displacement between any input images by using a machine learning method to estimate an initial guess for ICP. Any new input image does not have to have any overlap with any preceding input image.

Particularly, aspects of the invention as disclosed herein propose a method to estimate an accurate spatial transformation between the coordinate systems of a new input depth image and an existing 3D model. Further, aspects of the invention as disclosed herein propose an efficient way of merging the information of the new input depth image to the existing 3D model. N is a positive integer, according to an embodiment is at least 1.

The following aspects and embodiments as described below may be applied individually or in any combination with the aspects of the invention as described above and in any combination with other aspects and embodiments of the present invention as described below.

According to an embodiment, the method further comprises a step (g) of merging at least part of the N-th plurality of 3D features with the 3D model according to the N-th accurate transformation. Particularly, by merging at least part of the N-th plurality of 3D features with the 3D model according to the N-th accurate transformation, the 3D model is updated. According to an embodiment, such updated 3D model may be used in a following iteration loop (particularly in step 1009), wherein steps (c) to (g) are iterated at least once or multiple times and N is increased by 1 in each iteration loop.

According to an embodiment, the method further comprises providing a first input depth image of at least part of the object of interest, wherein a first image coordinate system is associated with the first input depth image, providing a first plurality of 3D features in a first image coordinate system according to the first input depth image, estimating a first coarse transformation between the object coordinate system and the first image coordinate system according to the trained pose model and the first input depth image, and determining the 3D model for step (b) defined in the object coordinate system according to the first plurality of 3D features. In this embodiment, N in steps (c) to (f), or (c) to (g) is at least 2 or higher (depending on which iteration loop is currently being performed, wherein N is increased by 1 in each iteration loop, see embodiment below). Thus, for example, in the first iteration loop, in which steps (c) to (f), or (c) to (g) are iterated for the first time (i.e., steps (c) to (f), or (c) to (g) are performed for the second time), N is increased from 2 by 1, so that N is 3 (see also FIG. 1B described below).

According to an embodiment, steps (c) to (f) are iterated at least once, wherein N is increased by 1 in each iteration loop. According to another embodiment, steps (c) to (g) are iterated at least once, wherein N is increased by 1 in each iteration loop.

Particularly, the N-th input depth image may be an image of a real environment captured by a camera (herein also referred to as real image) or may be a synthetic image.

Advantageously, the object of interest is a face of a living object, such as a human or animal, particularly is a human face.

According to an embodiment, the trained pose model is determined according to a machine learning method. For example, determining the trained pose model comprises using the machine learning method according to a plurality of training images of training objects which are associated with poses of the training objects. The trained pose model may be a forest structure comprising a plurality of binary tree structures, wherein each leaf of the binary tree structures of the forest structure is associated with values about rotation according to at least one of ground truth rotations. For example, each respective training image of the plurality of training images is an image of a real environment captured by a camera or a synthetic image generated as captured by a camera, and a ground truth rotation of the training object in one of the training images is relative to the camera.

According to an embodiment, the accurate transformation describes a spatial relationship.

The method as described herein may be performed by a computer. All embodiments, aspects and examples described herein with respect to the method can equally be implemented by the processing device as described herein being configured (by software and/or hardware) to perform the respective steps. Any used processing device may communicate via a communication network, e.g. via a server computer or a point to point communication, with a camera and/or any other components.

For example, the processing device (which may be a component or a distributed system) is at least partially comprised in a mobile device which is associated with a camera for capturing images of a real environment, and/or in a computer device which is adapted to remotely communicate with the camera, such as a server computer adapted to communicate with a camera or mobile device associated with a camera. The system described according to the invention may be comprised in only one of these components, or may be a distributed system in which one or more processing tasks are distributed and processed by one or more components which are communicating with each other, e.g. by point to point communication or via a network.

According to another aspect, the invention is also related to a computer program product comprising software code sections which are adapted to perform a method according to the invention. Particularly, the software code sections are contained on a computer readable medium which is non-transitory. The software code sections may be loaded into a memory of one or more processing devices. Any used processing devices may communicate via a communication network, e.g. via a server computer or a point to point communication, as described herein.

### BRIEF DESCRIPTION OF THE DRAWINGS

Aspects and embodiments of the invention will now be described with respect to the drawings, in which:

FIG. 1A shows a flow diagram of a method according to an embodiment of the invention for determining a transformation between an image coordinate system and an object coordinate system associated with an object of interest.

FIG. 1B shows a flow diagram of a method according to another embodiment of the invention for determining a transformation between an image coordinate system and an object coordinate system associated with an object of interest.

FIG. 2 shows an embodiment of a system setup for determining a transformation between an image coordinate system and an object coordinate system associated with an object of interest according to an example of the invention.

FIG. 3 shows an example of a bump image as used according to embodiments of the invention.

FIG. 4A shows a workflow diagram of an embodiment of determining a trained pose model according to a machine learning method.

FIG. 4B shows an exemplary forest structure comprising binary trees.

FIG. 5 shows examples of patches extracted in an image.

### DETAILED DESCRIPTION OF THE INVENTION

In the following, embodiments and exemplary scenarios are described, which however shall not be construed as limiting the invention.

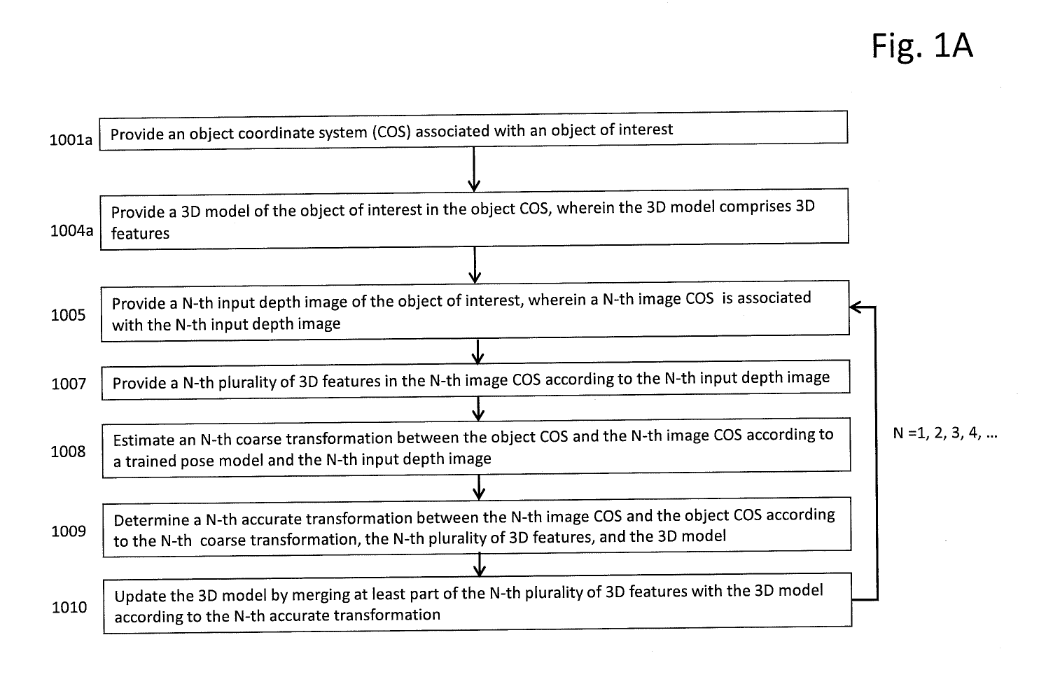

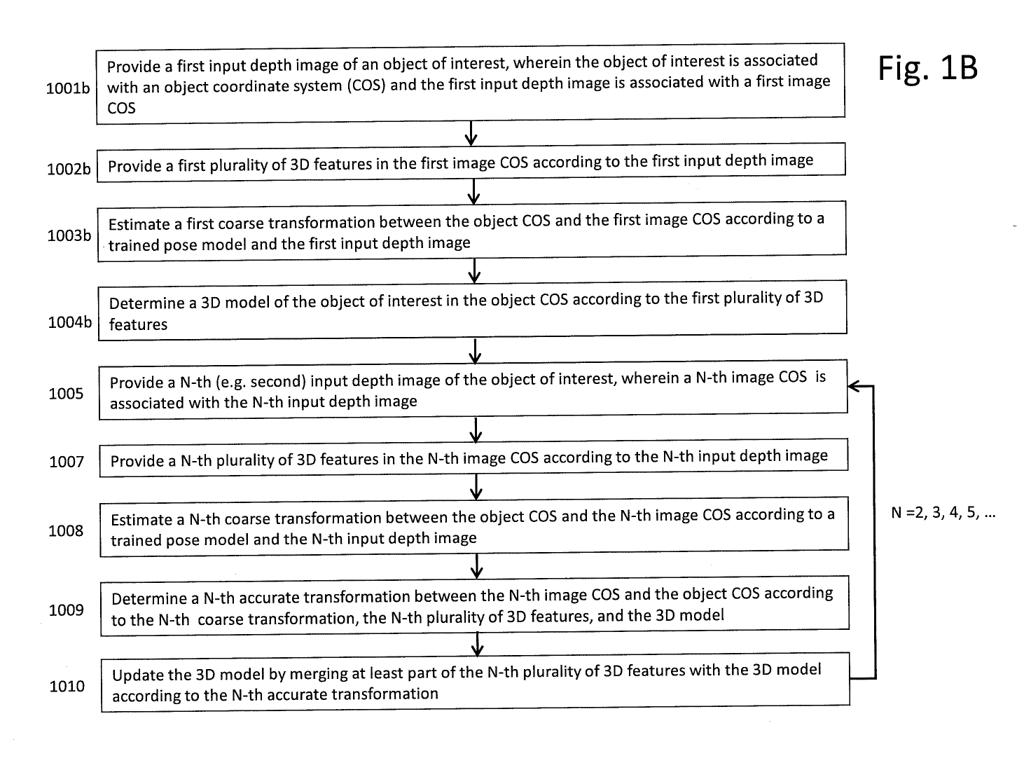

FIG. 1A and FIG. 1B shows a flow diagram of a method according to an embodiment of the invention for determining a transformation between an image coordinate system and an object coordinate system associated with an object of interest. Further, the FIGS. 1A and 1B each show an embodiment of a method for determining a 3D model of at least part of the object of interest.

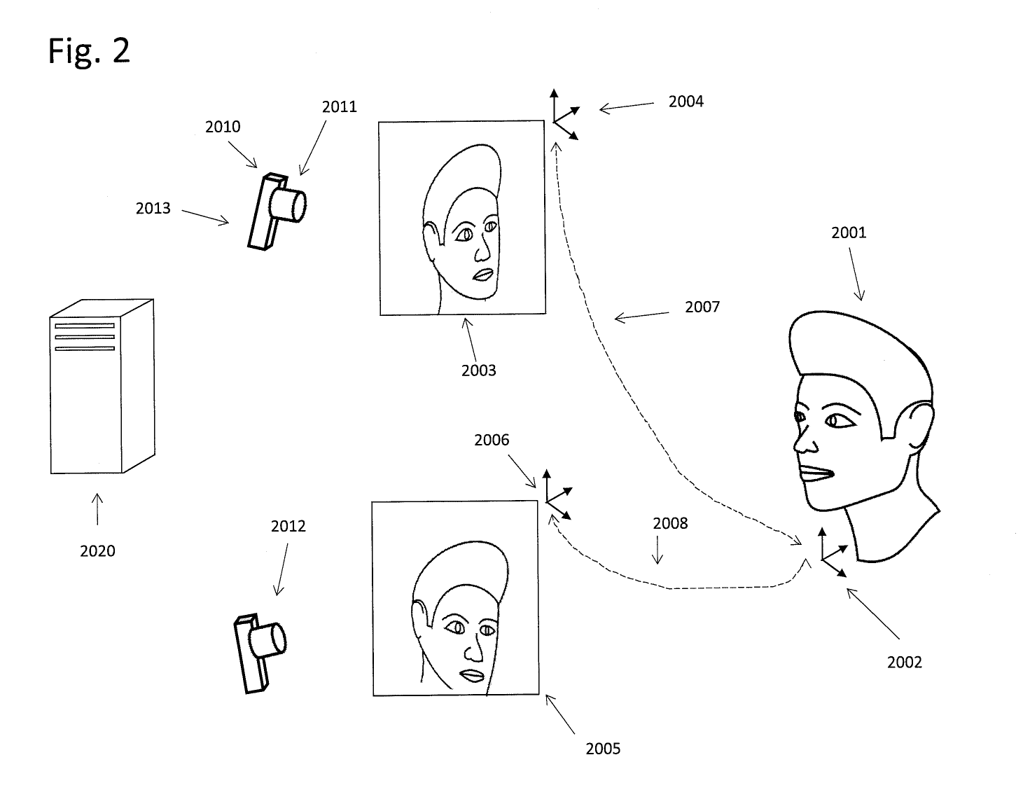

FIG. 2 shows an illustration of an exemplary arrangement of components according to an embodiment of the invention. Particularly, it shows a scenario with a 3D model of at least part of a human head 2001 which is determined according to depth images 2003 and 2005 captured by a depth camera 2010 at two different locations 2011 and 2012. It may also be two different depth cameras at two different locations 2011 and 2012.

In FIGS. 1A and 1B, the steps 1005 to 1010 are the same. A difference between the method according to FIG. 1A and the method according to FIG. 1B is that, in the method according to FIG. 1B, the 3D model of the object of interest is determined in steps 1001b to 1004b, whereas in the method according to FIG. 1A, the object coordinate system associated with the object of interest and a 3D model of the object of interest are provided in steps 1001a and 1004a.

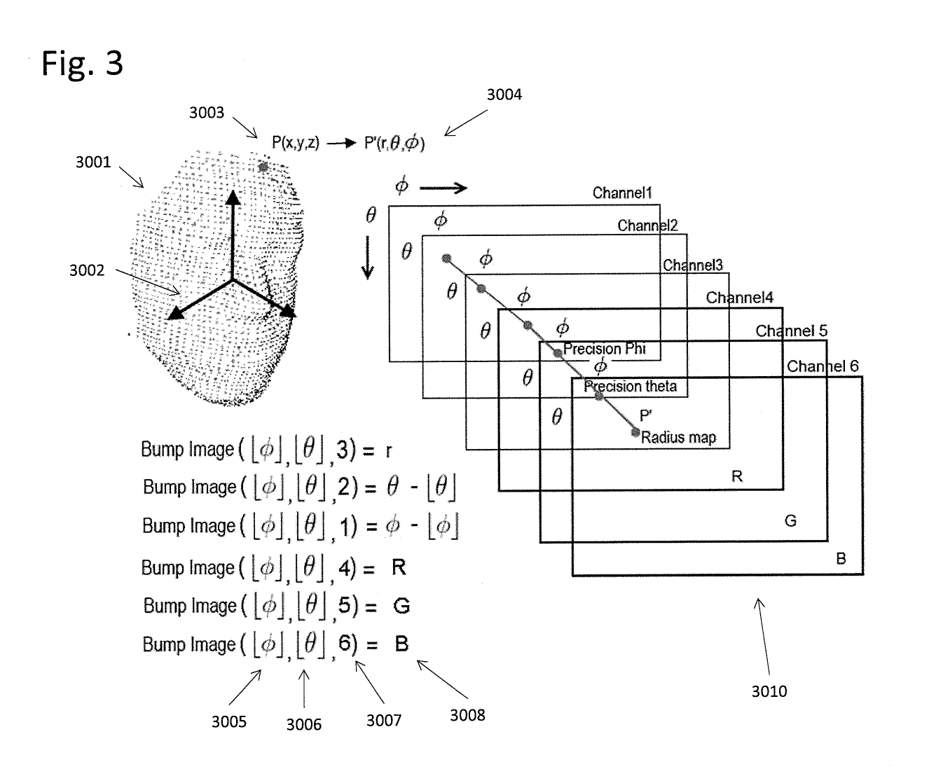

More particularly, referring to FIG. 1A, in step 1001a an object coordinate system (COS) associated with an object of interest is provided. Step 1004a provides a 3D model of the object of interest in the object COS, wherein the 3D model comprises 3D features. This 3D model may be used as a basis 3D model in the following steps 1005 to 1010 as described herein below. For example, the 3D model may be provided in the form of a data structure of a bump image, such as shown in FIG. 3.

Referring to FIG. 1B, step 1001b provides a first input depth image of an object of interest, wherein the object of interest is associated with an object coordinate system (COS) and the first input depth image is associated with a first image COS. For example, the first input depth image may be the depth image 2003 captured by the depth camera 2010 at the location 2011. The depth image 2003 captures a part of the human face 2001, which here is the object of interest. The human face 2001 has an associated COS 2002, which is the object COS. The depth image 2003 has an associated COS 2004, which is the image COS of the first input depth image. In this example, COS 2004 is the same as the camera COS of the depth camera 2010 at location 2011 while the depth camera 2010 captures the depth image 2003.

Step 1002b provides a first plurality of 3D features in the first image COS according to the first input depth image. In the example shown in FIG. 2, the first plurality of 3D features at least contains features of the human face 2001. For example, the first plurality of 3D features is a point cloud consisting of 3D points on at least part of the surface of the human face 2001.

For a point feature detected in the depth image 2003, determining its 3D coordinates in 3D space from its 2D coordinates (e.g. pixel) may be performed according to camera intrinsic parameters of the depth camera 2010 and depth information associated with the depth image 2003. The determined 3D coordinates are in the image COS 2004 (here the camera COS of the depth camera 2010 at the location 2011).

Step 1003b estimates a first coarse transformation between the object COS and the first image COS according to a pose estimation method (here trained pose model) and the first input depth image. In the example shown in FIG. 2, the transformation 2007 (indicated by dash lines 2007 in FIG. 2) between the face COS 2002 and the image COS 2004 is determined as the first coarse transformation. In this example, the transformation 2007 describes a pose of the depth camera 2010 relative to the face 2001 when the depth camera 2010 captures the depth image 2003. The transformation 2007 is a rigid transformation including a translational component and/or a rotational component. Before determining the first coarse transformation, the first input depth image may be smoothed and hole filled using a bilateral filter.

The transformation 2007 (i.e. the first coarse transformation) may be determined by using a machine learning method according to a trained pose model and at least part of the input image. The machine learning method could be random forest. The trained pose model may be represented by a data structure of a forest comprising a plurality of binary decision trees. In step 1003b, the depth information and/or color information associated with the image 2003 may not be necessary to be considered for determining the first coarse transformation. Section “Machine learning based coarse transformation estimation” below describes building the trained pose model according to a machine learning method and estimating the coarse transformation.

Step 1004b determines a 3D model of at least part of the object of interest in the object COS according to the first plurality of 3D features and the estimated first coarse transformation. In this step, the first plurality of 3D features may be first transformed from the first image COS to the object coordinate system according to the estimated first coarse transformation. The 3D model may be constructed by at least part of the first plurality of 3D features. The 3D model may be represented by a data structure of bump image.

In the example shown in FIG. 2, the bump image is a 2-D unwrapped spherical map of the head or face 2001. The bump image could represent the whole surface of the head or face 2001 with spherical coordinates. One location (indicated by spherical coordinates) of the bump image may be used to denote a 3D feature and one of the first plurality of 3D features may be represented at one location of the bump image. For example, one of the spherical coordinates could be used to denote a 3D point on the surface of the head or face 2001, when the first plurality of 3D features is a 3D point cloud of the head or face 2001.

It may not be possible to generate values at each of the locations (i.e. spherical coordinates) of the bump image by using the first plurality of 3D features determined from the first input depth image, as the first input depth image may only cover a part of the head or face 2001. Thus, a part of the bump image may not have values according to the first input depth image. Further, a value at one location of the bump image may be updated multiple times from several different input depth images.

A confidence mask with the same dimension as the bump image may be used to record how many times or if a certain location in the bump image has been processed. For example, each pixel of the confidence mask counts the number of times where the point at corresponding spherical coordinates in the Bump Image has been observed.

Steps 1005-1010 in both FIGS. 1A and 1B will be performed at least once and may be iteratively performed multiple times, wherein N increases by 1 in each iteration loop. One iteration loop comprises performing the sequence of steps 1005 to 1010 once, as evident from FIGS. 1A and 1B by the right arrow.

N is a positive integer, i.e. N=1, 2, 3, 4, 5, etc. According to the embodiment of FIG. 1A, N is at least 1, wherein N increases by 1 in each iteration loop. According to the embodiment of FIG. 1B, N is at least 2, wherein N increases by 1 in each iteration loop.

Step 1005 provides an N-th (e.g. a first (FIG. 1A) or second (FIG. 1B)) input depth image of the object of interest, wherein an N-th image COS is associated with the N-th input depth image. In the example shown in FIG. 2, the N-th input depth image is the depth image 2005 captured by the depth camera 2010 at the location 2012. The depth image 2005 captures a part of the head or face 2001 and is associated with the COS 2006 that is the Nth image COS. The COS 2006, in this example, is the same as the camera COS of the depth camera 2010 at the location 2012.

Step 1006 provides an N-th plurality of 3D features in the N-th image COS according to the Nth input depth image in a similar way as in step 1002b. In the example shown in FIG. 2, the N-th plurality of 3D features at least contains features of the human head or face 2001. For example, the N-th plurality of 3D features is a point cloud comprising 3D points of the head surface. 3D features (e.g. 3D points) of at least one rigid part of the object of interest may be preferred to be determined to be as at least part of the N-th plurality of 3D features. For example, rigid parts of the head may be nose, cheek, and ear. Points of the nose may be selected as at least part of the N-th plurality of 3D features. Points of the cheek may be selected as at least part of the N-th plurality of 3D features. Points of the nose and points of the cheek may be comprised in the 3D model. Further, 3D features (e.g. 3D points) of deformable parts of the object of interest may not be selected as at least part of the N-th plurality of 3D features. For example, deformable parts of the head are, but not limited to, mouth. Points of the mouth may not be selected as at least part of the N-th plurality of 3D features. Points of the deformable parts may introduce inaccuracy to some standard ICP methods.

The determined 3D coordinates of the point cloud are in the image COS 2006 (here the camera COS of the depth camera 2010 at the location 2012).

Step 1007 estimates an N-th coarse transformation between the object COS and the N-th image COS according to a trained pose model and the N-th input depth image in a similar way as in step 1003.

In the example shown in FIG. 2, the transformation 2008 (indicated by dash lines 2008 in FIG. 2) between the face COS 2002 and the image COS 2006 is determined as the N-th coarse transformation. In this example, the transformation 2008 describes a pose of the depth camera 2010 relative to the head or face 2001 when the depth camera 2010 captures the depth image 2005. The transformation 2008 is a rigid transformation including a translational component and/or a rotational component. Before determining the N-th coarse transformation, the N-th input depth image may be smoothed and hole filled using a bilateral filter.

The transformation 2008 (i.e. the N-th coarse transformation) may be determined by using a machine learning method according to a trained pose model and at least part of the input image. The machine learning method could be random forest. The trained pose model may be represented by a data structure of a forest consisting of a plurality of binary decision trees. In step 1008, the depth information associated with the image 2005 may not be necessary to be considered for determining the N-th coarse transformation.

The N-th coarse transformation is not accurate enough, particularly by using the machine learning method to estimate the transformation. A Kalman filter may be used to smooth the coarse transformation estimated by the machine learning method.

In most cases, it is necessary to obtain a more accurate transformation. This is particularly important for reconstructing a 3D model of the object of interest from multiple images of the object of interest. The 3D reconstruction requires accurate spatial transformations between the multiple images or accurate spatial transformations of the object of interest relative to each of the multiple images.

Step 1009 determines an N-th accurate transformation between the N-th image COS and the object COS according to the N-th coarse transformation, the N-th plurality of 3D features, and the (updated) 3D model.

If the 3D features are point features, different kinds of iterative closed point (ICP) methods may be employed to determine the N-th accurate transformation by matching at least part of the N-th plurality of 3D features with at least part of the 3D features of the 3D model. The ICP method requires an initial guess. The estimated N-th coarse transformation may be used as an initial guess for the ICP method to match between the at least part of the N-th plurality of 3D features and the at least part of the 3D features of the 3D model. Estimation of a good initial guess for ICP is a remaining challenge in state of the art. None of the references [2, 3, 7, 8, 9, 10, 11, 12] proposes to train a pose estimation model by a machine learning method (e.g. random forest method) with a plurality of training images in order to estimate an initial guess for the ICP method.

In step 1009 of determining the N-th accurate transformation, points (i.e. 3D features) from different rigid parts (e.g. nose and cheek of the head) may be treated differently in ICP when aligning the N-th plurality of 3D features with the 3D features of the 3D model. In one embodiment, error tolerance for aligning between the 3D points of the nose contained in the at least part of the N-th plurality of 3D features and the 3D points of the nose contained in the at least part of the 3D features of the 3D model may be smaller than aligning between the 3D points of the nose and cheek contained in the at least part of the N-th plurality of 3D features and the 3D points of the nose and cheek contained in the at least part of the 3D features of the 3D model. The error tolerance may be used as a criteria of stopping the iteration in ICP.

A Kalman filter may be used to smooth the determined N-th accurate transformation. This is explained below in section “Smoothing the transformation estimation”.

Step 1010 optionally updates the 3D model by merging at least part of the N-th plurality of 3D features with the 3D model according to the N-th accurate transformation. The following shows an example embodiment of steps 1009 and 1010 of updating a 3D model of a head by merging a depth image of the head to the existing 3D model. The 3D model of the head is represented by a bump image. In this example, 3D features are point features.

The frame-to-global model (FGM) framework is superior over the frame-to-reference frame (FRF) framework. The FGM framework comprises dynamically updating the model with live depth measurements while using it to register incoming depth images. Particularly, the 3D model (bump Image in the present case) is initialized with the first input depth image and then augmented by the subsequent input depth images. For the N-th input depth image, a current projected depth image may be generated from the current 3D model by transforming the 3D model with a previously estimated pose (i.e. the coarse or accurate transformation of a (N−1)-th input depth image) or with the N-th coarse transformation and rendering the transformed 3D model in OpenGL context, and then the N-th depth image is aligned to the current projected depth image.

Compared to using the previously estimated pose (like in references [3,7]), an advantage of using the N-th coarse transformation estimated from a trained pose model according to the present invention is that the method according to the invention does not require the (N−1)-th and N-th input depth images captured from two close viewpoints.

To efficiently perform the FGM framework, two tasks are of major importance: (1) integration part (i.e. how to update the 3D model with incoming frames) and (2) depth image prediction (i.e. how to quickly and accurately generate a depth image from the updated 3D model). For the task (1) we employ the view-centric integration strategy that takes into account the directional bias of the noise in the depth image, and we contribute in the task (2) by demonstrating the potential of interoperability between OpenGL and CUDA for fast depth image generation using a spherical Bump Image.

Depth Measurements' Integration:

We employ the running average to integrate new measurements (i.e. a plurality of 3D features determined from the N-th input depth image) in the 3D model while reducing input noise. In order to minimize the noise a temporal mean filter is employed and points lying within, e.g., 1 cm deviation to the 3D model are subjected to mean filtering. In order to perform temporal mean filtering, another buffer with similar dimensions of the Bump Image is maintained, this buffer/image also known as confidence mask has one-to-one correspondence to all the pixels in the Bump Image and it records the weighted frequency of appearance of each pixel in the Bump Image. Note that an implicit assumption for this approach to be efficient is that all measurements that are averaged together should come from the same point on the head (i.e. the object of interest). A glaring example is that averaging points belonging to the nose with those belonging to the ear does not work. This is why registering input image (i.e. estimating a transformation between the image COS of the input image and the object COS) has to be done before integration. However, even if the registration process is successful, a problem may arise due to noise when integrating new depth measurements (i.e. 3D features) into the Bump Image. The fact is that, due to noise the same point viewed in two different images may be projected into different pixel coordinates in the Bump Image, and also two different points of the head may be projected into the same pixel of the Bump Image. This results in erroneous averaging computations.

In order to avoid this problem, the integration process should be executed directly in the camera plane domain rather than in the Bump Image domain. This is because the noise in a depth image obtained with an RGB-D camera is mainly distributed along the viewing direction. From the current projected depth image, we first align the N-th input depth image (i.e. incoming depth image) to the projected depth image using ICP using a point to plane metric and the N-th coarse transformation as initial guess. From this, the N-th accurate transformation may be obtained. The N-th input depth image or the 3D model may be transformed according to the N-th accurate transformation in order to align them with each other. In one embodiment, the 3D model may be transformed according to the N-th accurate transformation to obtain an aligned 3D model, which is aligned with the image COS of the N-th input depth image (e.g. the camera plane domain when the camera captures the N-th depth image).

From the above explanation it is evident that the depth measurement integration should take place in the camera plane domain. At this stage the images to be merged are the N-th input depth image and the current projected depth image. The pose from ICP, i.e. the N-th accurate transformation, is used to align the current projected depth image with the N-th input depth image. The temporal mean between the aligned images (frames) is performed with the help of confidence values that are recorded for each point in the 3D model, i.e. the confidence mask. To perform the depth integration the confidence mask which is in the Bump Image domain must be projected to the camera plane domain. This projection is carried out during the stage where the current projected depth image in the camera plane is generated. Thus at every pixel in the current projected depth image, there is a confidence value associated with it.

To perform temporal mean between the two depth images (N-th input depth image and aligned current projected depth image), it is essential to weigh the depth from the current projected depth image based on the weighted frequency of its appearance, i.e. its corresponding confidence value. The word “weighted” is stressed as every new depth pixel in the N-th input depth image can have a weight of at most 1. Since the depth precision changes with distance it is better to encode the uncertainty of depth at different distances in the weights. This is done by weighing each new depth pixel in the N-th input depth image by a confidence of

Mask(i,j)=min (1.0,²⁰/_{depth}2)

The confidence value associated with current projected depth at pixel (i,j) is denoted as πMask(i,j). Given D_{N}(i,j) as depth in the N-th input depth image at pixel (i,j) and πD(i,j) as aligned current projected depth image at pixel (i,j), the averaged depth is estimated as

$${D}_{mean} ( i , j ) = \frac{{Mask}_{N} ( i , j ) * {D}_{N} ( i , j ) + πMask ( i , j ) * π D ( i , j )}{{Mask}_{N} + πMask} ,$$

a similar expression is used to compute the texture at pixel (i,j),

$${rgb}_{mean} ( i , j ) = \frac{{Mask}_{N} ( i , j ) * {rgb}_{N} ( i , j ) + πMask ( i , j ) * π rgb ( i , j )}{{Mask}_{N} + πMask}$$

where rgb_{N} is the texture information in the N-th image and πrgb is the texture of the current projected 3D model. The confidence value is updated after computing the weighted average,

Mask_{updated}(i,j)=πMask(i,j)+Mask_{N}(i,j).

The merged depth image estimated by the temporal mean process (as explained above) is used to update the Bump Image. The updating of Bump Image depends on the confidence values associated with each pixel in the Bump Image and the newly estimated confidence values. A pixel in the Bump image is updated if and only if the estimated confidence value at that location has a higher confidence than what it previously had. After updating the Bump Image which is the 3D model, it is projected back to the camera plane to form the new projected depth image and then transform the new projected depth image according to a previously estimated pose in the N-th frame. This serves as the projected depth for (N+1)-th frame. It may also be possible to apply an estimated (N+1)-th coarse transformation to transform the new projected depth image that will serve as the projected depth image for a (N+1)-th input depth image. Compared to using the previously estimated pose for the N-th frame (like in reference Anasosalu Pavan Kumar et al. “Compact and Accurate 3-D Face Modeling Using an RGB-D Camera: Let's Open the Door to 3-D Video Conference.” Proc. of 3rd IEEE Workshop on Consumer Depth Cameras for Computer Vision (CDC4CV2013), pp. 67-74, 2013), one advantage of using the (N+1)-th coarse transformation estimated from a trained pose model according to the present invention is that the method does not require both the N-th and (N+l)-th input depth images captured from two close viewpoints.

Smoothing the Transformation Estimation:

We employ a filter (for example, a Kalman filter) to smooth the temporal inconsistencies and stay on the trajectory when there is an erroneous or no pose/location output from the random forest. Likewise, particle filter could also be employed here. For face pose estimation from RGBD data, knowing an estimated location of the face center in the image can help achieve higher processing speed and accuracy. For most practical videos, the face center changes only by a few pixels from one frame to the next. We use the face center (nose tip) from the previous frame as the expected location of the face center in the current frame. This assumption works well in a majority of the frames. However occasionally the face position changes by more than a few pixels and the above approximation fails. To avoid this situation, we use a Kalman filter to track and smooth the estimated 3D location of the nose tip.

A Kalman filter is a 2-step filtering process that maintains a state for the object and uses the observations from the data to update the state. The first step is to predict the state in the current frame based on the state in the previous frame. The second step is to update the predicted state by taking into account the observations in the current frame. In our system, the nose tip location (x,y,z values) and velocity of the nose tip (along x,y,z directions) are maintained as the state. The observations are the predicted nose tip location from the random forest. In frames where the random forest returns a reliable nose tip estimate, we perform Kalman prediction and update steps to obtain the filtered nose tip location. In frames where the random forest does not return a reliable nose tip estimate, only the Kalman prediction step is performed. This allows the Kalman filter to continuously track and smooth the face center. By varying the covariance values associated with the states and the observations in the Kalman filter, the filter can be designed to track the observations with different amount of lags. The usefulness of the Kalman filter is in estimating a good prediction for the estimated nose tip when the random forest fails to obtain a confident pose prediction using the previous frame's unfiltered nose tip.

Machine Learning Based Coarse Transformation Estimation:

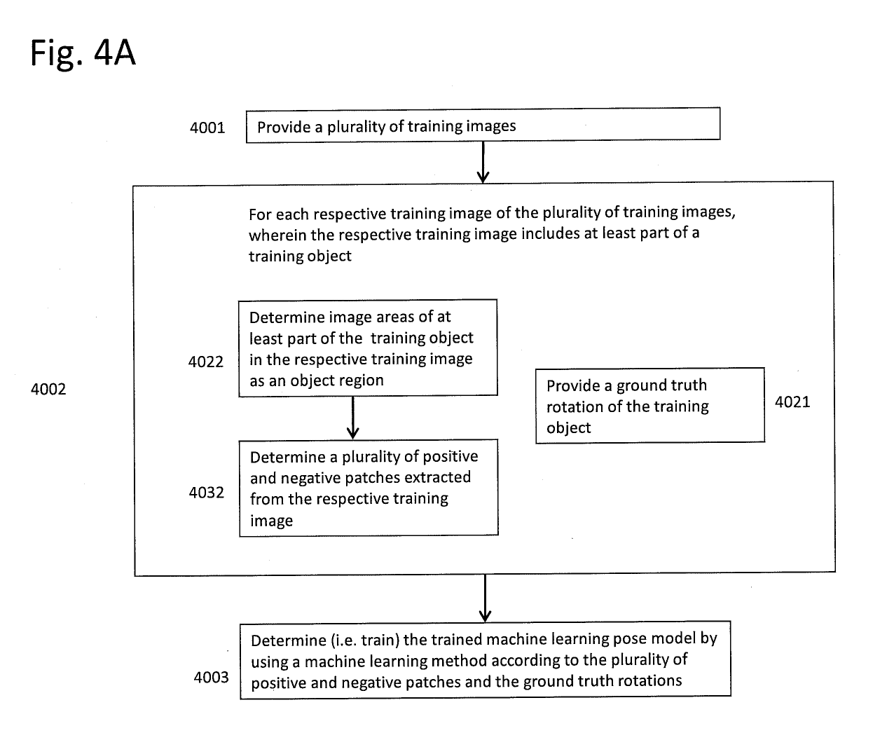

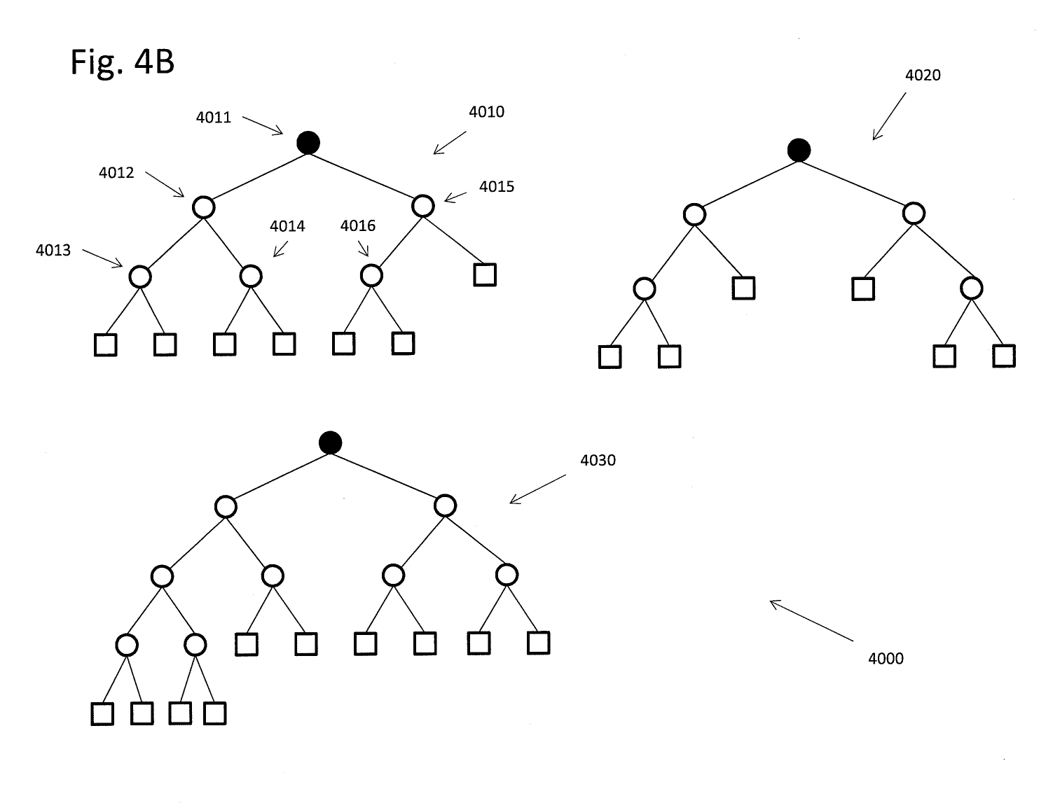

FIG. 4A shows a workflow diagram according to an embodiment of determining a trained pose model. Step 4001 provides a plurality of training images. Like the input image, each respective training image of the plurality of training images may be a real image captured by a camera (i.e. an image of a real environment captured by a camera) or a synthetic image. The synthetic image may be generated as captured by a camera. Each respective training image includes (e.g. captures or visualizes) at least part of a training object. A part of the plurality of the training objects captured in the plurality of training images may be same or different objects. For example, a same human face may be captured in a plurality of images by one or more cameras. In another example, different faces of different people may be captured in a plurality of images by one or more cameras.

Step 4002 includes steps 4021, 4022, and 4032 that are performed for each respective training image of the plurality of training images.

Step 4021 provides a ground truth pose (e.g. ground truth rotation) of the training object captured or visualized in the respective training image. The ground truth rotation may be relative to a camera that captures the respective training image. The ground truth rotations may be obtained by using suitable sensors or expensive and accurate tracking setups.

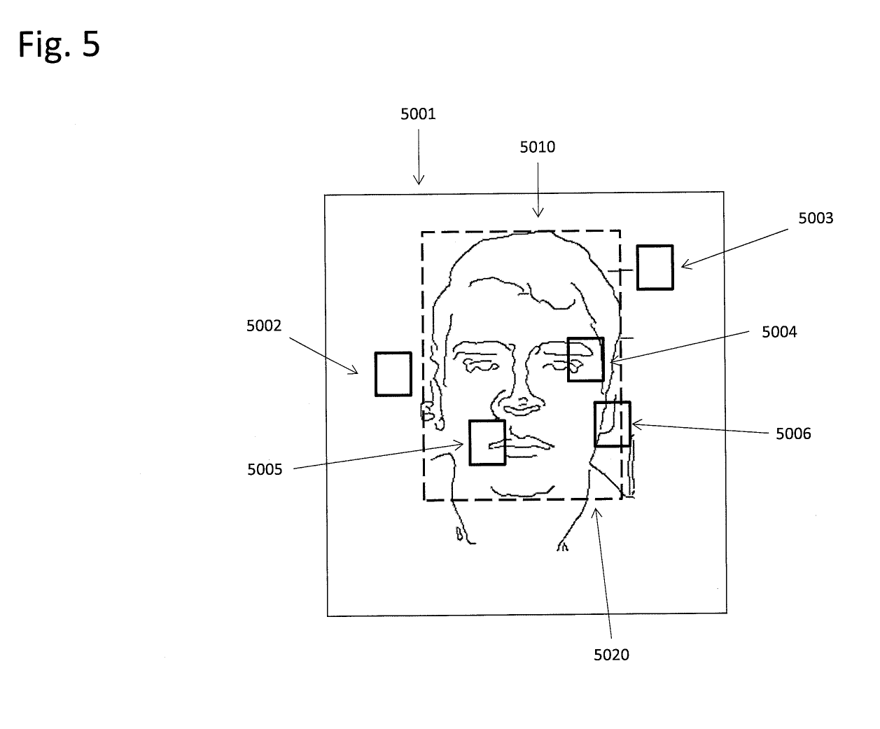

Step 4022 determines or provides image areas of at least part of a training object in the respective training image as an object region. There may exist one image area or more disconnected image areas of the at least part of the training object. In one example as shown in FIG. 5, the detection of the face 5010 using an off-the-shelf face detector generates the face bounding box 5020 (dash line) in the image 5001. In this case, the face bounding box 5020 is an object region.

Step 4032 determines or provides a plurality of positive and negative patches extracted from the respective training image. A patch is positive if the patch is within the object region and a patch is negative if the patch is out of the object region. When a part of a patch is within the object region and rest part of the patch is out of the object region, the patch is rejected and it is neither positive nor negative. A patch is an image region within the image, for example, a rectangle region.

In one example as shown in FIG. 5, the patches 5002 and 5003 are negative patches. The patches 5004 and 5005 are positive patches. The patch 5006, which is rejected, is neither positive nor negative.

The head or face orientation from ground truth data is obtained by using a marker based tracking method that uses a known marker pose with respect to the camera coordinate system. Positive patches are extracted from facial region and negative patches are extracted from non-facial region. Each positive patch is annotated with a vector v=(vₓ,v_{y}) that joins the center of the patch to the nose tip and the head orientation θ=(θ_{yaw}, θ_{pitch}, θᵣₒₗ₁). A number of such positive patches are extracted from each depth image. For negative patches however, there is no associated vector v and orientation θ. These extracted positive and negative patches are then used to train the Random Forests algorithm.

Step 4003 determines (i.e. trains) the trained pose model by using a machine learning method according to the plurality of positive and negative patches and the ground truth rotations. In an example, the trained pose model is a forest structure comprising a plurality of binary tree structures, wherein each leaf of the binary tree structures of the forest structure is associated with values about rotation. The values about rotation may be determined according to at least one of the ground truth rotations. The machine learning method could be a random forest method (as described in Breiman, Leo. “Random forests.” Machine learning 45.1 (2001): 5-32) for determining the forest structure.

FIG. 4B shows a forest structure 4000 comprising three binary trees 4010, 4020, and 4030. For each of the binary trees, circles without fill indicate internal node and squares indicate leafs. The circles with the fill indicate the root and each of the binary tress has one root node.

A trained forest structure may comprise at least one decision tree. For example, the at least one decision tree may be a binary decision tree 4010 as shown in FIG. 4B. At the nodes 4011, 4012, 4013 and 4015, the object poses are used for decision, while at the nodes 4014 and 4016, the object feature locations are used for decision.

In an embodiment of determining the trained pose model for determining a face pose, a set of patches (typically a few tens) are extracted from each training image (example patches are 5001-5006 shown in the FIG. 5). Patches that happen to lie on the face (face regions are marked in the training images) are considered ‘positive’ patches and patches that do not lie on the face are ‘negative’ patches. The ground truth poses of the face for each training image may be stored along with the patch information. The goal of the model is to then learn an association between the information in the patches and the expected output variable. Many machine learning models such as boosting and Support Vector Machines can be used for this purpose.

Random forests (such as in Lowe, David G. “Object recognition from local scale-invariant features.” Computer vision, 1999. The proceedings of the seventh IEEE international conference on. Vol. 2. Ieee, 1999) may be used to train the pose model, which are known for their robustness and learning ability. The random forest algorithm can be replaced by any suitable machine learning algorithm. The learning algorithm for the random forest implementation basically learns a tree where a decision is made at each internal node on how to split the observed patches into two subsets. The decision rule at each internal node acts as a test that determines which subtree (left or right) to push an observed patch to. The key to learning an effective random forest is to ensure that the split made at each node results in subtrees that are meaningful towards the eventual goal (estimating the rotation of the face). This is achieved by choosing a decision rule (from a set of randomly generated rules) that splits the patches into two groups such that the sum of the entropies of the distribution of rotation values in the two groups is minimized. In practice, a decision rules consists of two rectangular regions within the patch and a threshold value. If the difference between the cumulative feature values of the two rectangles is greater than the threshold, the patch is considered to have passed the test and sent to the left subtree. If the difference is less than the threshold value, then the patch fails the test and is sent to the right subtree. By cumulative feature values, it means the sum of all feature values within the given rectangular region. The rectangular regions are generated to be of random size and at random locations within the given patch. The thresholds for each decision rule are picked from a set of randomly generated threshold values. When a given maximum depth is reached or number of patches reaches a node, a node is considered to be a leaf and the mean and variance of all the rotation values are computed for patches that have reached the leaf. When all the input patches have been pushed to their destination leaf nodes, the training phase of one tree is complete. Multiple trees are learned with different decision rules thus resulting in a forest of trees.

An embodiment implementation is based on random forests for estimating the coarse transformations (e.g. in steps 1003b and 1008).

In the scenario shown in FIG. 2, when a random forest is to be used to estimate the coarse pose from an input image (e.g. image 2003 or 2005), patches are extracted (either at random or in a dense sampling scheme) from the input image using face detection. Then, the patches are propagated through the trained pose model (i.e. a trained forest of binary trees in this example). When the patches reach leaf nodes, the trained mean and variance values for profile angle values at these leaves are used to estimate the coarse pose for the observed face image.

Mean shift or other robust techniques are used to obtain a confident solution from multiple trees in the forest.

The method described above could also be used for step 4012 of determining a rotation of the training object according to the trained pose model.

Possible System Setup:

FIG. 2 shows an exemplary system setup for determining a transformation between an image coordinate system and an object coordinate system associated with an object of interest (here: object COS 2002 associated with head or face 2001). The system setup is also appropriate for determining a 3D model of the head or face 2001. The camera 2010 captures two input depth images 2003 and 2005 at two different locations 2011 and 2012. The camera 2010 may communicate with a processing device 2020, such as a microprocessor of a computer, via cable or wirelessly. The method according to the invention as disclosed herein may be performed at least in part by the processing device 2020.

The camera 2010 may be integrated into a mobile device 2013, such as a smartphone or mobile computer, comprising a processing device (not shown) where the procedure and embodiments thereof as disclosed herein may also be performed at least partly. The mobile device 2013 and processing device 2020 can also build a distributed system, or they can perform the procedure individually. The processing device 2020 may generally be implemented in, e.g., a mobile device worn or held by the user, a server computer or in any of the cameras described herein. It may be configured by hardware and/or software to perform one or more tasks as described herein.

In Augmented Reality (AR) applications, virtual visual content (like a computer generated object) may be overlaid onto an image of an object of interest based on a reconstructed 3D model of the object of interest. In one example of AR applications, a virtual glasses may be generated and overlaid onto an image of a human head. A 3D model of the human head may be required to select a proper size of the virtual glasses or adjust the shape of the virtual glasses. Depth images of the head may be captured by using a depth camera. The 3D model of the head could be generated according to the method disclosed in this invention. The virtual glasses could be overlaid onto any of the captured depth images of the head according to at least part of the reconstructed 3D model of the head. An embodiment of determining poses of the head and a 3D model of the head may be used in AR shopping applications, e.g. shopping glasses or hat. Particularly, as deformable parts of the head (mouth) may not be selected as 3D features, the accuracy of pose estimation and 3D reconstruction would be improved for upper parts (rigid parts, e.g. nose, cheek) of the head. This is highly valuable for the AR applications of glasses or hat shopping.

According to an embodiment, determining the N-th accurate transformation between the N-th image coordinate system and the object coordinate system comprises generating a current plurality of 3D features (i.e. a current depth image) by transforming the 3D features of the 3D model, with determining the N-th accurate transformation being performed by aligning the N-th plurality of 3D features and the current plurality of 3D features, wherein an initial guess for the aligning is determined from the N-th coarse transformation.

As described herein, the merging of at least part of the N-th plurality of 3D features with the 3D model is further performed according to confidence values associated with the 3D model. For example, the 3D model is represented by a bump image, wherein coordinates in the bump image each have an associated confidence value.

According to the present invention, a significant advantage over SLAM is that SLAM has undetermined scale factor, while the coarse transformation according to the present invention has a scale as the object of interest. Further SLAM estimates a pose of a current image relative to a reconstructed model of an object, but not relative to the object. Thus, the pose has undetermined scale factor.

Generally, the following aspects and embodiments may be applied in connection with aspects of the present invention.

Image:

According to the present invention, an image (e.g. an input image or training image) is any data depicting or recording visual information or perception. The image could be a 2-dimensional image. The image could also be a depth image. The image could be a real image or a synthetic image. The real image may be captured by a camera capturing a real environment. For example, the camera could capture an object of interest or a part of the object of interest in a real image. A synthetic image may be generated automatically by a computer or manually by a human. For example, a computer rendering program (e.g. based on openGL) may generate a synthetic image of an object of interest or a part of the object of interest. The synthetic image may be generated from a perspective projection as it is captured by a camera. The synthetic image may be generated according to orthogonal projection.

A depth image particularly is a 2D image with a corresponding depth map. The depth images do not need to be provided in the same resolution as a 2D (color/grayscale) image.

An image coordinate system (COS) associated with an image is a 3D coordinate system with unit, such as, but not limited to, pixel, millimeter, or inch. Scale factors relating pixels to distance, such as pixels per inch (PPI), may be used to convert coordinates in the image COS between different units.

Camera:

The present invention can be applied to any camera providing images. It is not restricted to cameras providing color images in the RGB format. It can also be applied to any other color format and also to monochrome images, for example to cameras providing images in grayscale format or YUV format. The camera may further provide an image with depth data (herein referred to as input depth image).

The depth data does not need to be provided in the same resolution as the (color/grayscale) image. A camera providing an image with depth data is often called depth camera. A depth camera system could be a time of flight (TOF) camera system, or a passive stereo camera, or an active stereo camera based on structured light. The invention may further use a light field camera. The depth camera system could be a time of flight (TOF) camera system. Kolb et al. in “Time-of-Flight Sensors in Computer Graphics”. Eurographics 2009 give an overview on state of the art of time of flight camera sensors and applications which may be applied herein.

The camera may also be simulated by a virtual camera. The virtual camera is defined by a set of parameters and can create images of virtual objects or scenes, which are synthetic images. A crucial parameter of a virtual camera may be its pose, i.e. 3D translation and 3D orientation with respect to the virtual object or scene. Virtual cameras may use the pinhole camera model and in this case the camera's intrinsic parameters include the focal length and the principal point. Common implementations of virtual cameras use the OpenGL rasterization pipeline, ray casting or ray tracing. In any case virtual cameras create views (i.e. two-dimensional images) of (potentially 3D) virtual objects by approximations of the capturing process happening when a real camera images a real object. In Augmented Reality, the intrinsic and extrinsic parameters of a camera are usually chosen to be consistent either with a real camera or such that they correspond to a setup of an Augmented Reality system.

An image coordinate system associated with an image may be the same as a camera coordinate system associated with a camera while the camera captures the image.

Obtaining, for a feature in a depth image, 3D coordinates in 3D space from its 2D coordinates (e.g. pixel) may be performed according to camera intrinsic parameters and associated depth information.

Object:

In the present invention, an object (e.g. object of interest or training object) is any real object or computer-generated object. A real object may be any object existing in a real environment and having physical appearance or structure. For example, the real object may be a person, a face of a person or a heart of a person. The real object could also be a tree, a car, a paper or a city. The real object may be captured by a camera in an image. The real object may also be visualized in a synthetic image.

A computer-generated object may be generated by a computer and have visual appearance. The computer-generated object could be a computer-generated figure, e.g. a computer-generated 2D or 3D model of a human face or head. The computer-generated object may be displayed on a screen or projected to a wall using a projector. The computer-generated object may be captured by a camera by using the camera to take an image of the screen or the wall while displaying the object. The computer-generated object may also be recorded or visualized in a synthetic image.

Feature:

Features are for example, but not limited to, points, edges, lines, segments, corners, or any other geometrical shapes. A feature may describe a specific color and/or structure, such as a blob, an edge point, a particular region, and/or a more complex structure of an object. A feature may be represented by an image patch (e.g. pixel intensity) or a high level descriptor (e.g. SIFT, as described in Lowe, David G. “Object recognition from local scale-invariant features.” Computer vision, 1999. The proceedings of the seventh IEEE international conference on. Vol. 2. Ieee, 1999.

Features may also be color information or textures of the object. For example, facial features associated with a face could be eye corners, nose tips, mouth corners, silhouette of mouth, silhouette of eye, and color of skin or eye. Features of an object may be visualized or captured in an image of at least part of the object. Object features may also be represented in a 3D model of the object. The position of an object feature in the image or in the 3D model may be represented by one or more coordinates or represented by one or more mathematical formulas.

A 3D feature may have 3D position and/or 3D orientation information in 3D Euclidean space relative to a reference coordinate. A feature may also be expressed in 2D space, which is a 2D feature. For example, a feature may be extracted from a 2D image, and thus the feature may have a 2D image position (e.g. pixel position) and/or orientation. When a depth image could provide depth information, 3D features may be extracted from the depth image, and 3D position and/or orientation information of the 3D features in a coordinate system of the depth image could be determined from image properties, such as pixels per inch (PPI) and pixel positions of corresponding 2D features.

Features may be mathematically represented by at least one coordinate (discrete representation) or by at least one mathematic formula (continuous representation) in a 2D or 3D coordinate system. For example, a circle or a sphere may be represented by a set of points or by an equation in a 2D or 3D coordinate system. A circle that is a 2D shape may be defined in a 2D or 3D space. The sphere that is a 3D geometry may be defined in a 2D space as a projection of the sphere (i.e. 3D shape) onto the 2D space.

Transformation:

A transformation typically describes a spatial relationship between objects or coordinate systems, e.g. between two objects or between two coordinate systems, or between an object and a coordinate system. It specifies how an object or a coordinate system is located in 2D or 3D space in relation to an object or coordinate system in terms of translation, and/or rotation, and/or scale. The transformation may be a rigid transformation or could also be a similarity transformation. A pose of a camera or of an object relative to a coordinate system is a rigid transformation.

3D Model:

A 3D model may describe a geometry for an object or a generic geometry for a group of objects. For example, a 3D model may be specific for an object. A 3D model may not be specific for an object, but may describe a generic geometry for a group of similar objects. A similar object may belong to the same type of object and share some common properties. For example, faces of different people are of same type since they are a respective face that has eye, mouth, ear, nose, etc. Cars of different types or brand are of same type since they are a car that has four tires, at least two doors, and a front window glass, etc.

A 3D model of a face may not be the same as any real existing individual face, but it is similar to the existing individual face. For example, the silhouette of the face of the 3D model may not exactly match the silhouette of the existing individual face, but they have all the shape of eclipse.

Geometry refers to one or more attributes of the object including, but not limited to, shape, form, surface, symmetry, geometrical size, dimensions, and structure. The model of the real object or the computer-generated object could be represented by a CAD model, a polygon model, a point cloud, a volumetric dataset, an edge model, or use any other representation. The model may further describe the material of the object. The material of the object could be represented by textures and/or colors in the model. A model of an object may use different representations for different parts of the object.

The 3D model can further, for example, be represented as a model comprising 3D vertices and polygonal faces and/or edges spanned by these vertices. Edges and faces of the model may also be represented as splines or NURBS surfaces. The 3D model may in this case be accompanied by a bitmap file describing its texture and material where every vertex in the polygon model has a texture coordinate describing where in the bitmap texture the material for this vertex is stored. The 3D model can also be represented by a set of 3D points as, for example, captured with a laser scanner. The points might carry additional information on their color or intensity.

The 3D model may also be a bitmap. In this case, the geometry of the object may be a rectangle while its material may be described for every pixel in the bitmap. Additionally, pixels in the bitmap might contain additional information on the depth of the imaged pixel from the capturing device (camera). Such RGB-D images are also a possible representation for the 3D model and comprise, both, information on the geometry and the material of the object.

The 3D model may also be a bump image (see FIG. 3). The bump image is also called canonical 2-D map (e.g., unwrapped sphere or a cylinder) to represent an object (e.g. a face or a car). The main advantage of using Bump Images compared to other standard 3-D representations such as volumes, cloud of points or Surfels is that it requires less amount of memory during processing or storing while guaranteeing similar accuracy. It is possible to employ an extension of the Bump Image representation to obtained 3-D models, namely, (1) use spherical coordinates instead of cylindrical coordinates (this allows to reconstruct the whole head but not just the face for example) and (2) use two additional displacement channels for the polar and azimuthal angles, as well as RGB channels.

FIG. 3 shows an example of a Bump Image as used according to embodiments of the invention. The Bump Image that represents a 3D model of an object is a 2-D unwrapped spherical map of the object. In one example, the object may be a head represented by a 3D model 3001 (e.g. a point cloud) in a coordinate system 3002. To build this spherical map, we have to first obtain points in the local coordinate system of the head. Once the points are transformed to the local coordinate system, explained below, the coordinate representation is changed from local Cartesian coordinates (indicated by 3003) to local spherical coordinates (indicated by 3004). The map 3010 is formed such that the horizontal distance on the map corresponds to φ and the vertical distance corresponds to θ. In FIGS. 3, 3005 and 3006 indicate coordinates in the map and 3007 indicates channel indices. The value (indicated by 3008) in the third channel can be represented by R(φ; θ), which denotes the radius value at a pixel corresponding to a specified φ and θ. The φ and θ are rounded off by discarding the decimal values, which gives a resolution of 1.0 degree. By losing out on decimal values a really coarse map is obtained, hence the lost precision in the first and second channels of the Bump Image could be recorded. The second channel encodes the lost precision of θ while forming the map; similarly the first channel encodes the lost precision of φ while forming the map. The lost precision can be computed as

θ_{precision}=θ−floor(θ),φ_{precision}=φ−floor(φ).

The remaining three channels encode the color (RGB) information.

In order to create the Bump Image, a local axis 3002 must be assigned to the head. The local axis is defined at the head location with help of pose estimated (e.g. from Random forest nose tip estimation), i.e. we transform the global axes centered at the camera to the head location using the pose estimated (e.g. from Random Forest estimation). Once local axes are known segmented points are transformed to the local Cartesian axes from global Cartesian axes before performing the transformation to spherical coordinates.

The 3D model may comprise 3D features. The 3D features may be point features. The 3D features of the 3D model may be defined at spherical coordinates of a Bump Image when the 3D model is represented by the bump image.

Although various embodiments are described herein with reference to certain components or devices, any other configuration of components or devices, as described herein or evident to the skilled person, can also be used when implementing any of these embodiments. Any of the devices or components as described herein may be or may comprise a respective processing device (not explicitly shown), such as a microprocessor, for performing all or some of the tasks as described herein. One or more of the processing tasks may be processed by one or more of the components or their processing devices which are communicating with each other, e.g. by a respective point to point communication or via a network, e.g. via a server computer.

1. A method of determining a transformation between an image coordinate system and an object coordinate system associated with an object of interest, comprising the steps of:
(a) providing an object coordinate system associated with the object of interest;
(b) providing a 3D model of at least part of the object of interest, wherein the 3D model comprises 3D features;
(c) providing an N-th input depth image of at least part of the object of interest, wherein an N-th image coordinate system is associated with the N-th input depth image, with N being a positive integer;
(d) providing an N-th plurality of 3D features in the N-th image coordinate system according to the N-th input depth image;
(e) estimating an N-th coarse transformation between the object coordinate system and the N-th image coordinate system according to a trained pose model and the N-th input depth image; and
(f) determining an N-th accurate transformation between the N-th image coordinate system and the object coordinate system according to the N-th coarse transformation, at least part of the N-th plurality of 3D features, and at least part of the 3D features of the 3D model.

2. The method according to claim 1, further comprising the step of:
(g) merging at least part of the N-th plurality of 3D features with the 3D model according to the N-th accurate transformation.

3. The method according to claim 1, wherein steps (c) to (f) are iterated at least once, wherein N is increased by 1 in each iteration loop.

4. The method according to claim 2, wherein steps (c) to (g) are iterated at least once, wherein N is increased by 1 in each iteration loop.

5. The method according to claim 1, the method further comprising the steps of:
providing a first input depth image of at least part of the object of interest, wherein a first image coordinate system is associated with the first input depth image;
providing a first plurality of 3D features in a first image coordinate system according to the first input depth image;
estimating a first coarse transformation between the object coordinate system and the first image coordinate system according to the trained pose model and the first input depth image; and
determining the 3D model for step (b) defined in the object coordinate system according to the first plurality of 3D features, wherein N is at least 2.

6. The method according to claim 5, wherein steps (c) to (f) are iterated at least once, wherein N is increased by 1 in each iteration loop.

7. The method according to claim 1, wherein the determining the N-th accurate transformation between the N-th image coordinate system and the object coordinate system model is performed by aligning the N-th plurality of 3D features and the current plurality of 3D features, wherein an initial guess for the aligning is determined from the N-th coarse transformation.

8. The method according to claim 2, wherein the merging at least part of the N-th plurality of 3D features with the 3D model is further performed according to confidence values associated with the 3D model

9. The method according to claim 8, wherein the model is represented by a bump image, wherein coordinates in the bump image each have an associated confidence value.

10. The method according to claim 1, wherein the N-th input depth image is an image of a real environment captured by a camera or is a synthetic image.

11. The method according to claim 1, wherein the object of interest is a face of a living object.

12. The method according to claim 1, wherein the trained pose model is determined according to a machine learning method.

13. The method according to claim 12, wherein determining the trained pose model comprises using the machine learning method according to a plurality of training images of training objects which are associated with poses of the training objects.

14. The method according to claim 13, wherein the trained pose model is a forest structure comprising a plurality of binary tree structures, wherein each leaf of the binary tree structures of the forest structure is associated with values about rotation according to at least one of the poses of the training objects.

15. The method according to claim 13, wherein each respective training image of the plurality of training images is an image of a real environment captured by a camera or a synthetic image generated as captured by a camera, and the pose of the training object in one of the training images is relative to the camera.

16. The method according to claim 1, wherein the accurate transformation describes a spatial relationship.

17. A non-transitory computer readable medium comprising software code sections which are adapted to perform a method of determining a transformation between an image coordinate system and an object coordinate system associated with an object of interest when running on a processing device, the method comprising:
(a) providing an object coordinate system associated with the object of interest;
(b) providing a 3D model of at least part of the object of interest, wherein the 3D model comprises 3D features;
(c) receiving an N-th input depth image of at least part of the object of interest, and providing an N-th image coordinate system associated with the N-th input depth image, with N being a positive integer;
(d) providing an N-th plurality of 3D features in the N-th image coordinate system according to the N-th input depth image;
(e) estimating an N-th coarse transformation between the object coordinate system and the N-th image coordinate system according to a trained pose model and the N-th input depth image; and
(f) determining an N-th accurate transformation between the N-th image coordinate system and the object coordinate system according to the N-th coarse transformation, at least part of the N-th plurality of 3D features, and at least part of the 3D features of the 3D model.

18. A device for determining a transformation between an image coordinate system and an object coordinate system associated with an object of interest, comprising at least one processing device which is configured to:
(a) provide an object coordinate system associated with the object of interest;
(b) provide a 3D model of at least part of the object of interest, wherein the 3D model comprises 3D features;
(c) receive an N-th input depth image of at least part of the object of interest, and to provide an N-th image coordinate system associated with the N-th input depth image, with N being a positive integer;
(d) provide an N-th plurality of 3D features in the N-th image coordinate system according to the N-th input depth image;
(e) estimate an N-th coarse transformation between the object coordinate system and the N-th image coordinate system according to a trained pose model and the N-th input depth image; and
(f) to determine an N-th accurate transformation between the N-th image coordinate system and the object coordinate system according to the N-th coarse transformation, at least part of the N-th plurality of 3D features, and at least part of the 3D features of the 3D model.

19. The device according to claim 18, wherein the at least one processing device is further configured to:
(g) merge at least part of the N-th plurality of 3D features with the 3D model according to the N-th accurate transformation.
